(19) United States
(12) Patent Application Publication
(10) Pub. No.: US 2009/0100109 A1
(43) Pub. Date: Apr. 16, 2009

(54) AUTOMATIC DETERMINATION OF ITEM REPLICATION AND ASSOCIATED REPLICATION PROCESSES

(75) Inventors: Andrzej Turski, Redmond, WA (US); Lili Cheng, Bellevue, WA (US); Matthew Maclaurin, Woodinville, WA (US); Shane F. Williams, Seattle, WA (US); Stacey Harris, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/873,401

(22) Filed: Oct. 16, 2007

(51) Int. Cl. G06F 17/00

(52) U.S. Cl. 707/200; 707/E17.005

(57) ABSTRACT

Architecture for replicating and sharing of data (e.g., different types) by analyzing the type and source of the data, analyzing the recipient entities (e.g., users, other devices or systems) that will receive the data, setting access to the data, and configuring rules and defaults for replication and security/access controls. For example, a user can share data with recipient entities such as another user or group of users or another system. The data can be uploaded to a server for access and sharing by the intended recipients or made accessible directly from the recipient computing system. Thus, the intended recipient can access the data directly without being required to register, for example. The architecture automatically and transparently makes the data accessible to the intended recipients based on a number of criteria.

### BACKGROUND

The computer user works with many different types of applications for interacting with computer functionality. Basic functionality is facilitated using programs such as email for communications, word processing for document generation and editing, spreadsheet for data processing, presentation for presenting information, multimedia for playback of audio and video, and the operating system for storing data associated with all of the above examples. These programs can be used to generate and/or receive data about a certain topic. Thus, data of the topic can be stored in different locations on the user machine (e.g., email in an email program, word processing document with the word proceeding application, etc.), or where the user is more organized, the related data can be manually stored in a folder, for example, such that all the data related to the singe topic is available in a single location.

In any case, a problem arises when the user wants to share this collection of information with another user, groups of user (e.g., project teams), and/or other user machines or devices. Moreover, the problem is further exacerbated when sharing occurs across network such that security is a concern and permissions must be considered. One cumbersome method of sharing data conventionally is to configure a share space on a server and require user registration and login in order to access the data. For example, one method of sharing photographs via the Internet involves registering with a website, uploading the pictures to a storage location and then communicating to the intended recipients the website address. The recipients are then required to register at the website to access the pictures, which is becoming more commonplace and an annoying impediment to the online user experience such as for simply wanting to access the pictures.

In another increasingly common example, users will typically have several computing platforms and devices via which to communicate, check messages, develop work product and search for other information. Thus, the user can have different sets and versions of the data stored across the different systems and devices. Ultimately, it then becomes desirable to share this data with other entities such as users and systems. For example, the user will typically want the latest data on the device which is being used. Similarly, the user will want other users or groups of users to have the latest data when collaborating on a project, for example.

However, there are no conventional mechanisms that provide a convenient and transparent way for the user to share or publish collections of information, in particular, dynamic collections such as associated with search results, because of the difficulty in assembling and managing access to these dynamic collections. These collections likely contain items that are stored in different places such as a user's local machine, the corporate enterprise of the user, on a network in a secure server, and/or on a network (e.g., the Internet) that is open to the public. More importantly, when sharing dynamic collections, users do not want to spend a lot of time managing replication settings, access controls, and security settings.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Disclosed is architecture that facilitates the replication and sharing of data (e.g., different types) by analyzing the type and source of the data, analyzing the recipient entities (e.g., users, other devices or systems) who will receive the data, setting access to the data, and configuring rules and defaults for replication and security/access controls.

In one example, a user searches the user computing system for all data related to a single topic, the results of which can be data of different types (e.g., word processor, spreadsheet, email message, etc.). The user then desires to share this data with recipient entities such as another user or group of users. The data can be uploaded to a server for access and sharing by the intended recipients or made accessible directly from the user computing system. The architecture automatically and transparently makes the data accessible to the intended recipients based on a number of criteria.

The source user can receive notifications associated with replicating the data and sharing the data with the intended recipients. For example, depending on the sensitivity of the information, the type and number of notifications needed can be automatically increased in order to publish the information. If publishing financial information and it is detected that this information is sensitive, the user can be prompted to “approve” publishing in secure email, as opposed to automatically updating the information.

Additional security measures (e.g., access for a shorter period, more sophisticated encryption, and automatic deletion after a designated time period) can also be added depending on the usefulness and sensitivity of the information.

In addition to inferring rules, defaults, and notifications, more efficient ways are provided for enterprises, websites, and end users to set new defaults and/or override existing settings on per-group or per-item basis.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented data management system for sharing data.

FIG. 2 illustrates an alternative system for data sharing and replication of static and dynamic data items.

FIG. 3 illustrates a system for replicating and sharing information among multiple entities.

FIG. 4 illustrates a method of managing data by sharing static and dynamic collections of data items.

FIG. 5 illustrates a method of processing characteristics the data items.

FIG. 6 illustrates a method of reducing scope of the sharing process.

FIG. 7 illustrates a method of updating a data item in the share location.

FIG. 8 illustrates a method of processing rules for sharing access to data items.

FIG. 9 illustrates a method of determining a communications mechanism for providing access to the shared data items.

FIG. 10 illustrates a method of maintaining a centrally located share of updated data items.

FIG. 11 illustrates a method of providing remote access to updated data items of a given application.

FIG. 12 illustrates a method of sharing personal items on a social network.

FIG. 13 illustrates a block diagram of a computing system operable to share static and dynamic collections of data items in accordance with the disclosed architecture.

FIG. 14 illustrates a schematic block diagram of an exemplary computing environment for sharing static and dynamic collections of data items.

### DETAILED DESCRIPTION

The disclosed architecture enhances the sharing experience for end users by making this experience simple and convenient, and reducing the burden of managing permissions and security settings. Users who have information which is secure and not intended for public exposure can now more easily share that information with the trust and confidence that the system is properly securing and handling the sharing of the information. Dynamic collections of information can be shared with a particular group of people, and the items for which people of the group should have access will be replicated and/or synchronized to a place where the information can be viewed while controlling access such that the appropriate people will have access to the right information.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

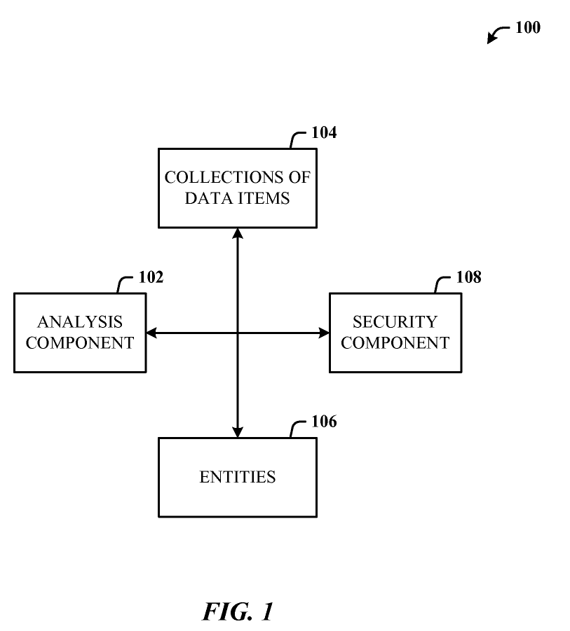

FIG. 1 illustrates a computer-implemented data management system 100 for sharing data. The system 100 includes an analysis component 102 for analyzing collections of data items (e.g., static and dynamic) 104 for sharing and analyzing entities 106 with which the data items will be shared. The system 100 also includes a security component 108 for managing access to the collections of data items 104 by the entities 106.

The system 100 can be employed in a client computer or device as a means for processing local search results for automatic sharing to different entities 106. The entities 106 can include different recipient users, different recipient systems, and one or more other systems of the user. For example, the source user (of the system 100) can desire to share the collection of data items 104 related to a project with other users working on the same project. The analysis component 102 will then analyze the intended recipient users and communicate with the security component 108 to determine if permission levels should be imposed for accessing the data items 104.

In a straightforward embodiment, the source user generates a search of the local system for data items 104 for transfer from a user source system (e.g., a desktop computer) to user recipient system (e.g., a portable computer) in a peer-to-peer (P2P) arrangement. The analysis component 102 analyzes and determines that the recipient system is that of the user, and the security component 108 will set the access level to facilitate the transfer over the connection. The connection can be a wire serial connection (e.g., USB, IEEE 1394) between the source and recipient systems. Alternatively, the connection can be a wireless connection via which the recipient system accessed the data items on the source system.

Note that when the user generates the collection of data items 104, in order to share the data items with the recipient system, these data items 104 can be replicated to a shared space on the source system. Thus, the security component 108 can limit access by the recipient system only to that shared space to retrieve the data items 104. This provides security to the source system in case the recipient system includes malware that would seek to undermine user programs and/or information on the source system. In this embodiment, the security component 108 provides total access to the shared space for retrieval of the data items.

In a home network scenario, it can be that the home user has a network device (e.g., a third computer system, a network storage device, external storage system. etc.) that can provide the shared space for receiving the replicated data items 104. In this case, the exposure of the source system (e.g., operating system) applications and data are less vulnerable to possible security breaches. As before, the security component 108 will analyze the intended recipient, in this case, another system of the user, and determine to allow total access to the data items 104 of the shared space, since the recipient is a system of the user.

In a similar example, the collection of data items generated by the source user can be replicated to a secure shared space of a storage space accessible from the Internet (e.g., an Internet website). In this case, the security component 108 can facilitate the uninhibited access to the shared space by the recipient user system, rather than the conventional registration process becoming required on a more frequent basis. This can be based on recipient data obtained from the source user, from automatic analysis of the recipient system for user and/or system identification information by the analysis component 102, information about the data items 104 to be shared as analyzed by the analysis component 102, and so on.

An alternative security mechanism places the items in an unsecured place (e.g., publicly accessible), but the security requirements can be fulfilled by encrypting the content. In such a case, access is controlled by giving the intended recipient the decryption key.

In another example, the recipient entities can be other employees with whom the source user wishes to share information. In this case, the collection of data items 104 generated by the source user can vary in sensitivity such that not all of the recipient users should be allowed to receive all of the data items 104. The source user system can replicate the data items (static or dynamic) to an external shared location such as a corporate enterprise server. When the source user specifies the intended recipients, the security component 108 analyzes this recipient information against the data items to determine if all of the intended recipients “qualify” for access to all of the data items 104. If so, sharing is as described above, and all recipients can access all of the shared data items.

In order for the recipient user(s) or systems to know of the shared data items, the source system user can communicate the availability and location of the shared space to the recipient entity(s) (e.g., users, systems). This can be via email that includes a pointer (e.g., URL) to the location (network or otherwise), a text message of the location, a directory service, or other conventional wire/wireless communications means. Moreover, the pointer to this shared space can be manually processed by recipient user(s) and/or automatically processed by the recipient system(s) thereby being transparent to the recipient user.

When the security component 108 processes the intended recipient entity(s) against the shared data items, the security component 108 can prompt the source user as to a security problem with one of the recipients accessing the data items. The user can then manually interact to allow or deny that recipient entity from accessing the shared data items.

In a more robust implementation, when the system 100 determines that not all of the intended recipients can access all of the shared data items, the shared space can further be segmented or partitioned into shared areas such that the recipient(s) that has limited access to some of the data items will be granted access to only those items, which are replicated into the shared area. For example, if there are ten data items, three of which can only be accessed by one of multiple recipient users, a shared area of the shared space can be generated into which these three data items will be replicated for access. Alternatively, the system 100 operates to send pointers to each of the ten items, in which case of limited access by some of the intended recipients, the system 100 will only send pointers to those data items in the shared space that these limited access recipients should see for retrieval. Thus, the system 100 can selectively grant access by the recipient entity(s) to the data items on a per-item basis.

An example of the data items that can be shared include a collection of data and/or information relevant to a project named “A”. The data items can include the following searches for sharing with home and work systems, with a project team, and with a collaborator outside the source user company: “pictures on my laptop about project “A”, “files in folder “A project” on my shared server names team project, “recent email and attachments about project A”, “documents on my company's website about project “A”, “new stuff from related projects “Kids Learning from Company X” on a search engine”, “new videos about A on a <social network>”, “new photos about A on <media sharing website>”, “product studio bugs on my corporate server about A”, “financial information about my project from my corporate server”, “things tagged A-share across the web”, “music for A from my laptop which has restricted access (e.g., due to digital rights management)”, etc.

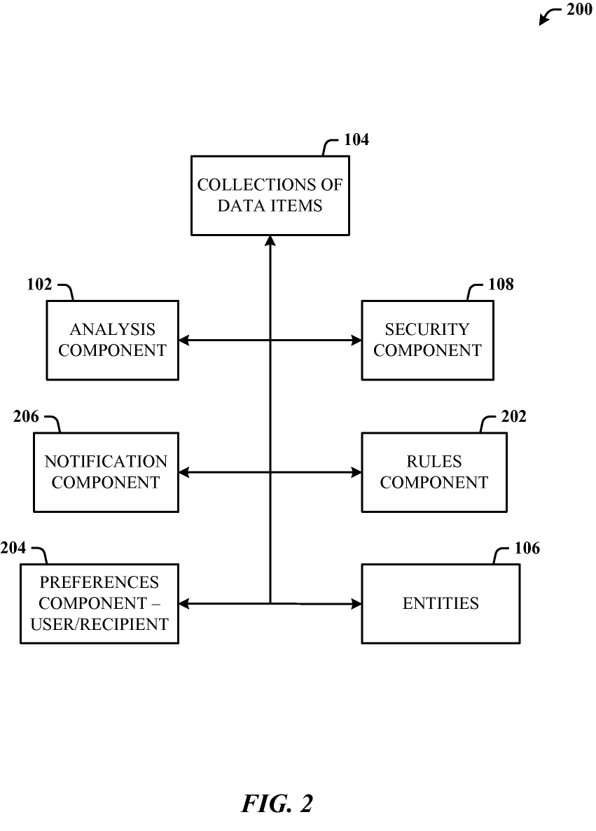

FIG. 2 illustrates an alternative system 200 for data sharing and replication of static and dynamic data items. The system 200 includes the analysis component 102, collections of data items 104, entities 106 and security component 108 previously described with respect to FIG. 1. The system 200 can further include a rules component 202 for the generation and processing of rules against the data items and entities, for example. The rules can be created and used by the source entity as a means for processing against the intended recipient entities. For example, a rule can be imposed that limits the file size of the data time to be shared, and thus, prompt the source entity to approve or remove the oversized data item from the share location or for sharing.

The rules component 202 can also include rules at a corporate level that restrict the sharing of collections of items based on corporate security policies. For example, the sharing of corporate data items to a non-employee can be managed via rules that limit or deny sharing entirely of a data item(s) in the share location. Rules can be generated to manage item sensitivity, content, file types, multiple shares for different permission levels of access, imposing time constraints on the ability to access the share, version control of the data items in the share location, a sliding window of data items over a predefined time period (e.g., the last two weeks), and so on.

The system 200 can also further include a preferences component 204 for storing and processing local user preferences and/or recipient entity preferences. For example, preferences can include the mode of communicating to access the share location. It is within contemplation that the data items to be shared can be replicated to more than one share location. In other words, one intended recipient entity may prefer to access the share location via a website. Thus, when the source notifies the recipient of the share location, a selectable link to the location for the entity can be a link to a public website. For the same replicated data items, a second recipient entity can access the data items via a secure server location of a local network. The recipient preferences can also be related to the type of device (e.g., cell phone versus desktop computer) that the recipient desires to receive notification or the mode of communication (e.g., email versus test messaging).

A notifications component 206 facilitates communicating the access information to the data items to the intended recipients. For example, the recipient can receive a list of links in the body of an email that directs the recipient to the source of a data item or a collection of the data items. The share location can also be included as an attachment which the recipient can then process to obtain the share location.

The data items can also be shared from different sources. In other words, the source can send links (or path information) that when executed direct the recipient to the respective sources of the information.

An initial assumption is that the sharer not only wants to share the information (data items) and make it accessible to the recipient(s), but also wants to be prudent about which information to replicate and to prevent the accidental sharing of sensitive information. In support of the sharing of collections of data items, ownership of a data item is determined as well as public/private access of the information, and sensitivity of the information.

For example, information that is not owned by sharer and is publicly available does not need to be replicated. If the information is already publicly accessible, no replication is performed. An example of this is “new stuff from related projects”, “Kids Learning from Company X”, and so on. In this case, the viewer's client can automatically query the information stored on website location of Company X. For information not owned by the sharer and is considered private, the information is not replicated for access by the recipient (viewer) and a warning (or notification) can be presented to the sharer (or source). An example of this is “financial information about my project from my corporate server.” To improve the user experience, again, the sharer is notified that the information will not be accessible to viewers without authorized access.

For information owned by the sharer and is considered private, this information can be replicated. In other words, when sharing data items owned by the sharer, but not accessible by the recipient viewer, then by default, that information is replicated to a mutually accessible location. An example of this is “pictures on my laptop about project A.”

For information that is partially owned by the sharer, private and type=communication, the information can be replicated with updates approved by sharer. In other words, when sharing data of type email/communication owned by the sharer, and not accessible to others, the information is replicated, but before updating changes, the sharer is prompted to “approve” before posting the information. An example of this is “email about project A.”

In some cases the ownership is unknown, or ambiguous. In this case, the sharer can be prompted to give provide feedback as to ownership. Depending on the situation, the scope of sharing can be reduced (e.g., reduce the number of people who can access, reduce discoverability/not put in directory, or make available for a limited amount of time). The sharer can also defer making the decision, and pass the decisionmaking prospect to the owner. An example of this is an IT (Information Technology) administrator determines that sharing information owned by the company must be stored in a particular location, and must follow pre-determined policy.

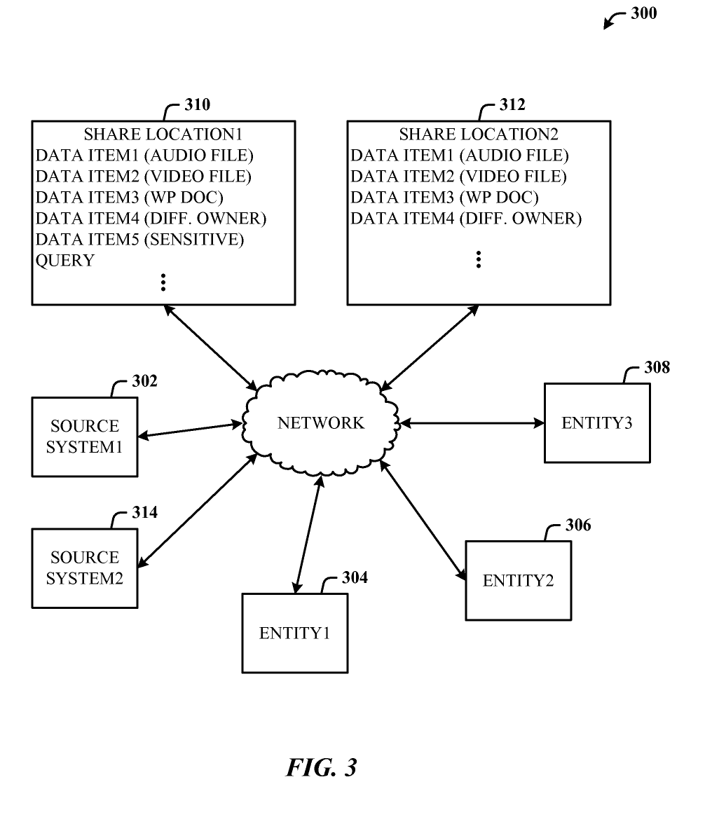

FIG. 3 illustrates a system 300 for replicating and sharing information among multiple entities. Here, a first source system 302 chooses to share data items with other entities: a first entity 304, a second entity 306, and a third entity 308. The data items include an audio file (denoted DATA ITEM1), a video file (denoted DATA ITEM2), a word processing document (denoted DATA ITEM3), a data item of a different owner (denoted DATA ITEM4), and a data item that is sensitive (denoted DATA ITEM5). In this case, not all of the entities (304, 306, and 308) are allowed to see all of the shared items (DATA ITEM1-5). Thus, the first source system 302 can configure two share locations: a first share location 310 and a second share location 312. The first share location 310 provides access to all of the data items (including the sensitive data item); whereas the second share location 312 share all data items except the sensitive data item.

When the first source system 302 identifies the entities to receive access to the data items, the first source system 302 (and associated components 102 and 108 of FIG. 1 or components 102 108, 202, 204 and 206 of FIG. 2) enforces the security processes such as to not allow the third entity 308 to view or access the sensitive data item. This can be an outright denial of access to the first share location 310, a prompt to the first source system 302 user to allow access by the third entity 308, or the creation of the second share location 312 such that the third entity 308 can still access all data items other than the sensitive item. The first entity 304 and second entity 306 can then be given full access to the data items in the first share location 310.

The data items replicated to the first share location 310 can be a result of an executed query. Alternatively or in combination therewith, the first source system 302 replicates the query itself to the first share location 310 (or second share location 312) such that the entity that accesses the share location 310 executes the query to obtain the associated data items. Thus, query execution can result in retrieving information from a second source system 314. This can be a delegation of the access rights from the first source system 302 to the entity (e.g., first entity 304) that allows the entity to further access other sources for the desired information.

It is further to be understood that the shared entities can access data items from the multiple source locations. Share locations (310 and 312) may have data items replicated from multiple source systems (e.g., first source system 302 and second source system 314). The multiple source systems (e.g., 302 and 314) can belong to the same user, or multiple users.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

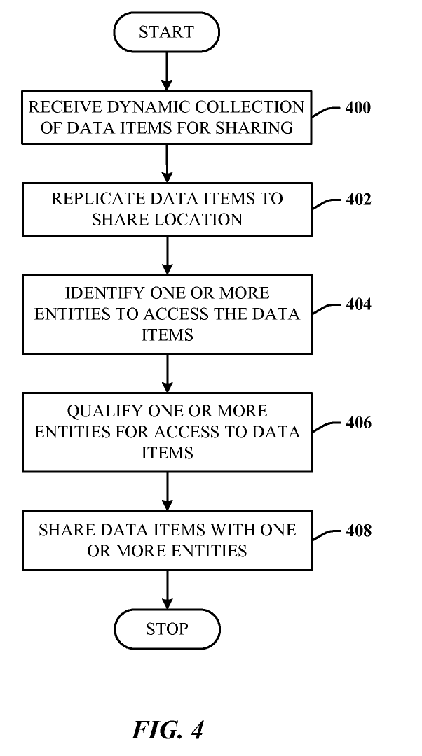

FIG. 4 illustrates a method of managing data by sharing static and dynamic collections of data items. At 400, a dynamic collection of data items is received for sharing. The collection can be generated as a result of executing a query on a local user machine. At 402, the data items are replicated to a share location. At 404, one or more entities are identified for accessing the share location and the data items. At 406, the one or more entities are qualified for accessing the data items. In other words, authentication can be provided such that only validated users and/or systems can access the share location to obtain the data items. At 408, the data items are shared with the accessing entity.

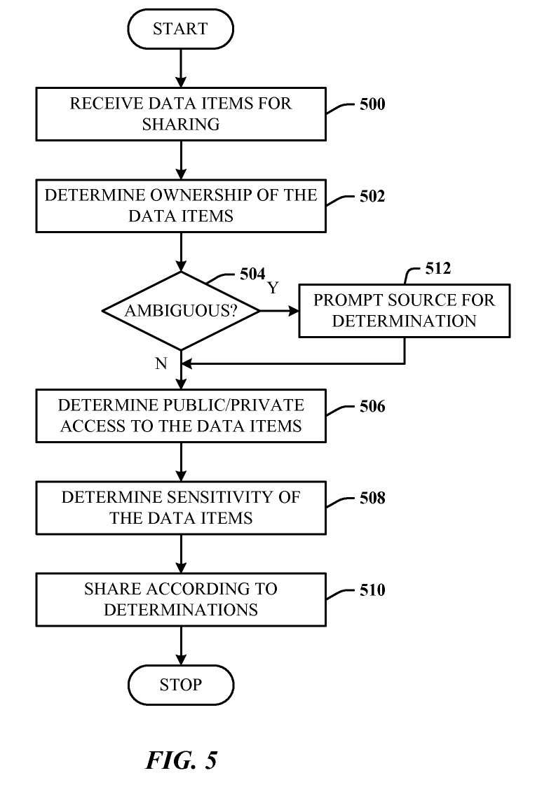

FIG. 5 illustrates a method of processing characteristics the data items. At 500, data items are received for sharing. At 502, ownership for each of the data items is determined. At 504, the system checks if ownership is ambiguous. If not, flow is to 506, public/private access to the data items is determined. In other words, if public access is allowed, no restrictions will be placed on accessing the data items. At 508, sensitivity of the data items is determined. This can be as a collection, or for each items separately. At 510, the data items are shared according to the above determinations. At 512, if the ownership is ambiguous, the source (e.g., user or item owner) can be notified and prompted to confirm or deny ownership.

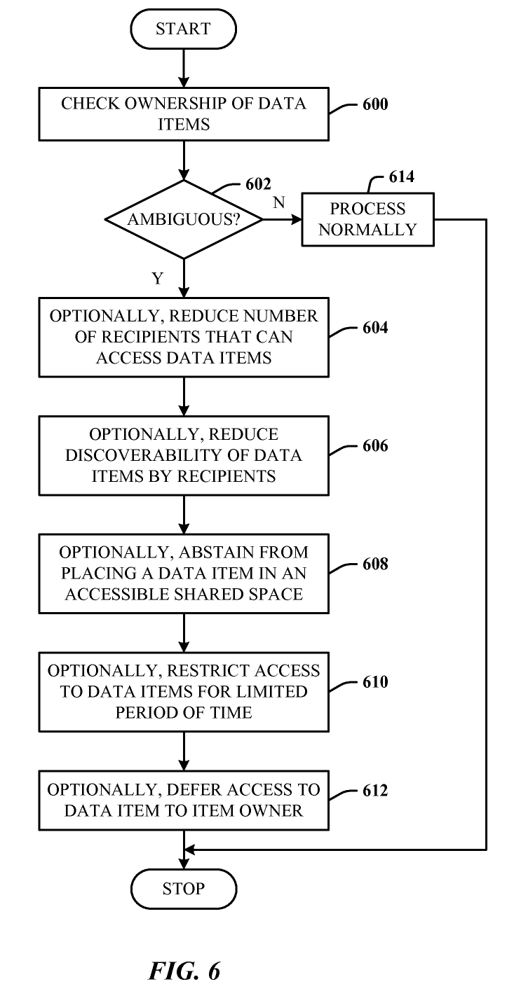

FIG. 6 illustrates a method of reducing scope of the sharing process. At 600, ownership of the data items is checked. At 602, if unknown or ambiguous, flow is to 604, to optionally reduce the number of recipients that can access the data items. At 606, optionally, the discoverability of a data item in the shared location by pointing only to specific data items. At 608, optionally, abstain from placing a data item in the share location. At 610, optionally, restrict access to the data items to a limited period of time. At 612, optionally, defer access determination to the owner of the data item. Alternatively, if ownership is not ambiguous or unknown, flow is from 602 to 614, to process ownership normally.

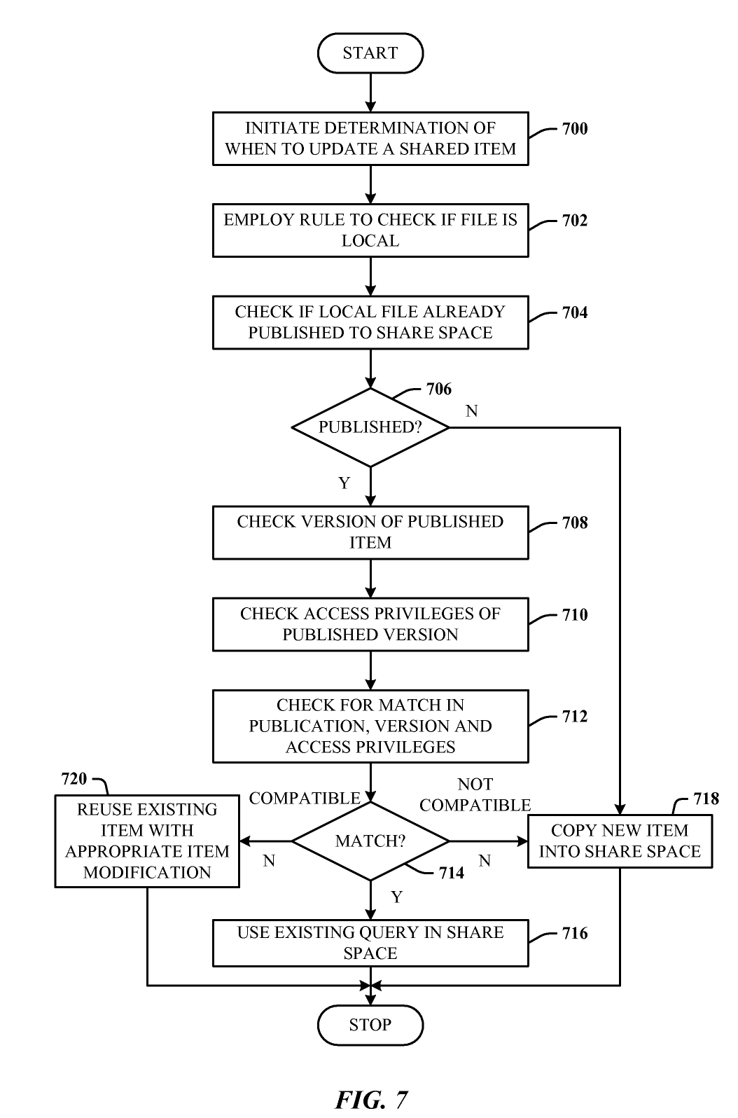

FIG. 7 illustrates a method of updating a data item in the share location. At 700, determination of when top update a shared item is initiated. At 702, a rule is employed to check of a file data item is local to a user system. At 704, a check is made to determine if the local file has already been published to the share space. At 706, if published, flow is to 708 to check the version of the published item. At 710, access privileges of the published version are then checked. At 712, a match in publication, version, and access privileges with performed between the local file and a shared data item. At 714, if a match is found, flow is to 716 to use the existing query in the share space. If a match is not found and there is not an existing compatibility, flow is from 714 to 718 to copy a new item into the share space for access by the intended recipients. If a match is not found and there is an existing compatibility, flow is from 714 to 720 to reuse the existing item with the appropriate item modification (e.g., update version or expand access rights). At 706, if not published, flow is then to 718 to copy the new item into the share space.

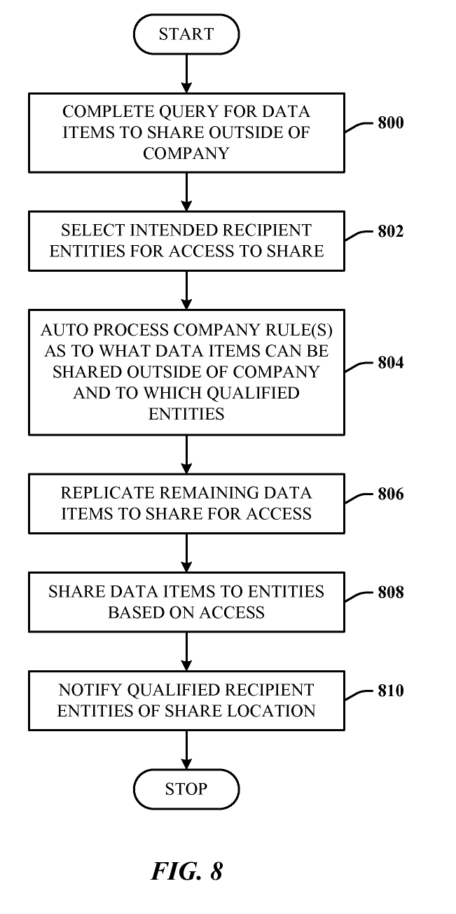

FIG. 8 illustrates a method of processing rules for sharing access to data items. At 800, a query is completed for sharing the data items outside of a company network. At 802, the intended recipient entities (e.g., users, systems) are selected. At 804, one or more company rules are automatically processed as to what data items can be shared outside the company network and to which of the qualified entities. At 806, the remaining data items are replicated to the share location for access. At 808, the data items are shared to the entities based on the access. At 810, the qualified recipient entities are notified of the share location. In an alternative implementation, notification can occur before sharing.

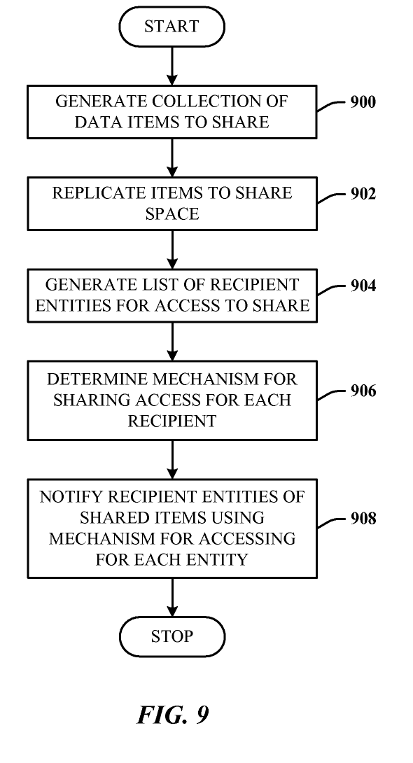

FIG. 9 illustrates a method of determining a communications mechanism for providing access to the shared data items. At 900, a collection of data items is generated for sharing. At 902, items are replicated to the share location. At 904, a list of recipient entities is generated for access to the share. At 906, a communications mechanism for sharing access for each recipient is determined. In other words, the mode of communicating to access the share can be different for the recipient entities. One entity may desire to access the share via a website, another entity via a shared server location, and so on. At 908, recipient entities are notified of the shared items using the mechanism of access each entity.

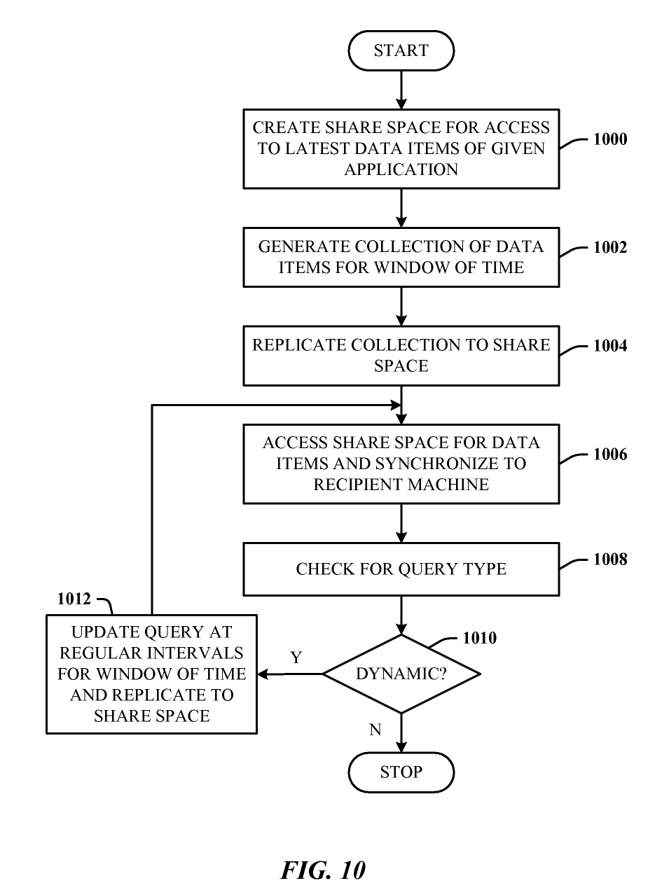

FIG. 10 illustrates a method of maintaining a centrally located share of updated data items. At 1000, a share space is created for access to the latest data items of a given application. At 1002, a collection of data items is generated for a window of time. At 1004, the collection is replicated to the share space. At 1006, the share space is accessed for synchronization of the data items to a recipient machine. At 1008, a check is made for the query type. At 1010, if the query type is dynamic (the query uses periodic updates), flow is to 1012 where the query is updated at regular intervals for a sliding window of time and the results replicated to the share space. Flow is then back to 1006. At 1010, if the query type is not dynamic (e.g., a static collection or individual items), flow then stops. An additional act can check of previously-published items should be updated. This can be considered as part of a standard item replication mechanism in contrast to the disclosed query replication.

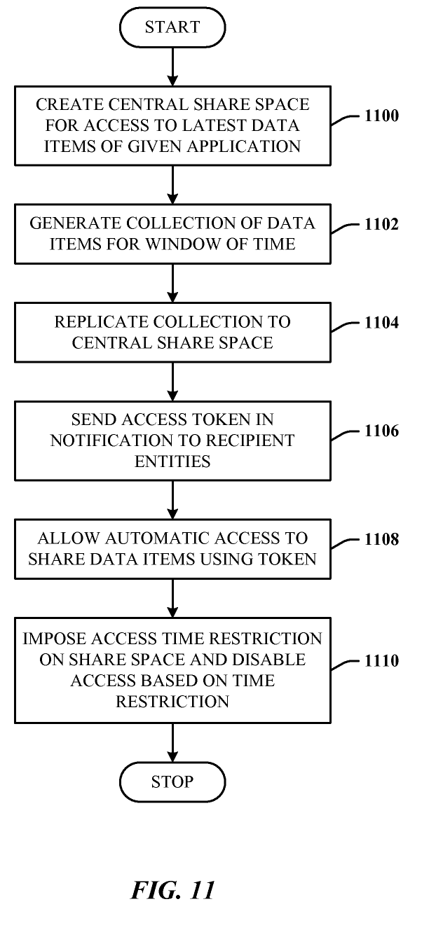

FIG. 11 illustrates a method of providing remote access to updated data items of a given application. This provides an always-accessible location (e.g., a secure network website) from which a user (or intended recipients) can obtain the latest set of information from anywhere. For example, the user can choose to have all emails in the last six months replicated to a secure web location or all emails with attachments in the last six months replicated to the location or all documents related to a project in the last week. At 1100, a central share space is created for access to the latest data items of a given application. At 1102, a collection of data items is generated over a sliding window of time. At 1104, the collection is replicated to the central share space. At 1106, an access token is sent in a notification to the intended recipients. At 1108, automatic access to the share data items is provided via the token. At 1110, an access time restriction is imposed on the share space and access is disabled based on the time restriction.

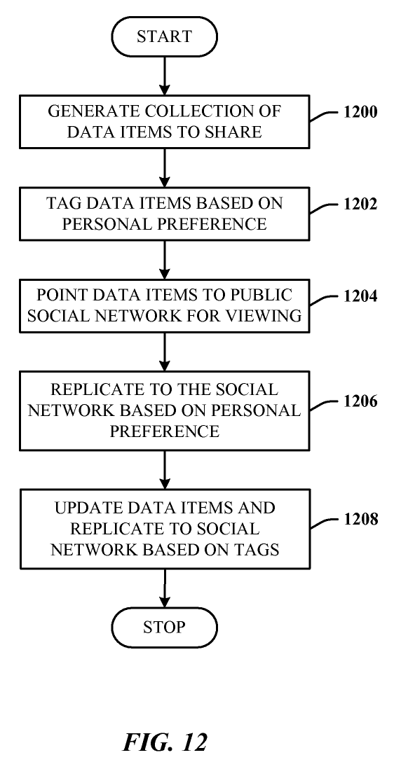

FIG. 12 illustrates a method of sharing personal items on a social network. At 1200, a collection of data items is generated to share. This can be a set of photos that the user wants to upload to a public social network for access and presentation. At 1202, the user tags the data items based on personal preferences. The user can prioritize the data items according to the tags and replication to the network site can be based on the tags. At 1204, the data items are pointed to the public social network for viewing. At 1206, the items are replicated to the network website based on the personal preferences. At 1208, the items replicated to the website can be updated based on the tags. In other words, the user can tag new photos for priority replication to the website.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

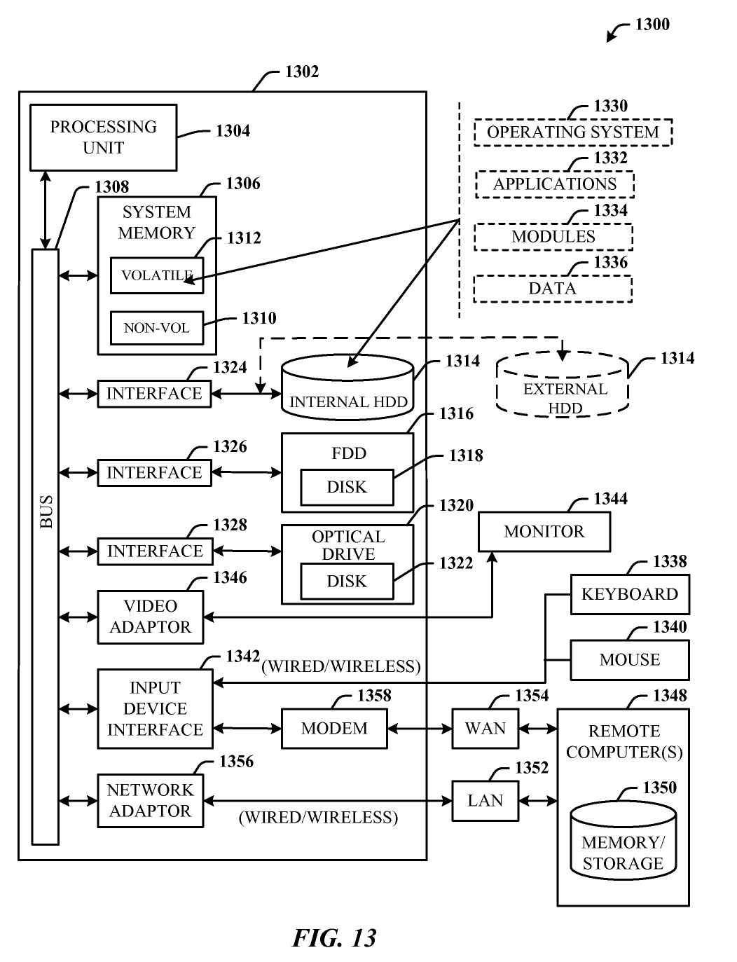

Referring now to FIG. 13, there is illustrated a block diagram of a computing system 1300 operable to share static and dynamic collections of data items in accordance with the disclosed architecture. In order to provide additional context for various aspects thereof, FIG. 13 and the following discussion are intended to provide a brief, general description of a suitable computing system 1300 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 13, the exemplary computing system 1300 for implementing various aspects includes a computer 1302 having a processing unit 1304, a system memory 1306 and a system bus 1308. The system bus 1308 provides an interface for system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 can include non-volatile memory (NON-VOL) 1310 and/or volatile memory 1312 (e.g., random access memory (RAM)). A basic input/output system (BIOS) can be stored in the non-volatile memory 1310 (e.g., ROM, EPROM, EEPROM, etc.), which BIOS contains the basic routines that help to transfer information between elements within the computer 1302, such as during start-up. The volatile memory 1312 can also include a high-speed RAM such as static RAM for caching data.

The computer 1302 further includes an internal hard disk drive (HDD) 1314 (e.g., EIDE, SATA), which internal HDD 1314 may also be configured for external use in a suitable chassis, a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as a DVD). The HDD 1314, FDD 1316 and optical disk drive 1320 can be connected to the system bus 1308 by a HDD interface 1324, an FDD interface 1326 and an optical drive interface 1328, respectively. The HDD interface 1324 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1312, including an operating system 1330, one or more application programs 1332, other program modules 1334, and program data 1336. The one or more application programs 1332, other program modules 1334, and program data 1336 can include the analysis component 102, collections of data items 104, security component 108, rules component 202, preferences component 204, and notification component 206, for example.

All or portions of the operating system, applications, modules, and/or data can also be cached in the volatile memory 1312. It is to be appreciated that the disclosed architecture can be implemented with various commercially available operating systems or combinations of operating systems.

A user can enter commands and information into the computer 1302 through one or more wire/wireless input devices, for example, a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces such as a parallel port, IEEE 1394 serial port, a game port, a USB port, an IR interface, etc.

A monitor 1344 or other type of display device is also connected to the system bus 1308 via an interface, such as a video adaptor 1346. In addition to the monitor 1344, a computer typically includes other peripheral output devices (not shown), such as speakers, printers, etc.

The computer 1302 may operate in a networked environment using logical connections via wire and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wire/wireless connectivity to a local area network (LAN) 1352 and/or larger networks, for example, a wide area network (WAN) 1354. Such LAN and WAN networking environments are commonplace in offices and companies, and facilitate enterprise-wide computer networks, such as intranets, all of which may connect to a global communications network, for example, the Internet.

When used in a LAN networking environment, the computer 1302 is connected to the LAN 1352 through a wire and/or wireless communication network interface or adaptor 1356. The adaptor 1356 can facilitate wire and/or wireless communications to the LAN 1352, which may also include a wireless access point disposed thereon for communicating with the wireless functionality of the adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wire and/or wireless device, is connected to the system bus 1308 via the input device interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

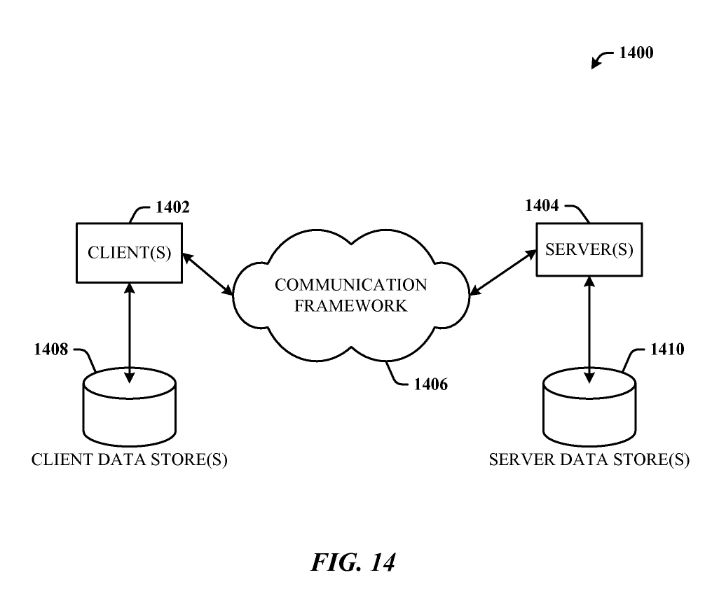

Referring now to FIG. 14, there is illustrated a schematic block diagram of an exemplary computing environment 1400 for sharing static and dynamic collections of data items. The environment 1400 includes one or more client(s) 1402. The client(s) 1402 can be hardware and/or software (e.g., threads, processes, computing devices). The client(s) 1402 can house cookie(s) and/or associated contextual information, for example.

The environment 1400 also includes one or more server(s) 1404. The server(s) 1404 can also be hardware and/or software (e.g., threads, processes, computing devices). The servers 1404 can house threads to perform transformations by employing the architecture, for example. One possible communication between a client 1402 and a server 1404 can be in the form of a data packet adapted to be transmitted between two or more computer processes. The data packet may include a cookie and/or associated contextual information, for example. The environment 1400 includes a communication framework 1406 (e.g., a global communication network such as the Internet) that can be employed to facilitate communications between the client(s) 1402 and the server(s) 1404.

Communications can be facilitated via a wire (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

The clients 1402 can include the entities 106 that are designated by the source system (or user) to be given access to the dynamic collections of data items, as well as the source system for determining the entities to receive notification and access to the collection of data items.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented data management system, comprising:
an analysis component for analyzing static and dynamic collections of data items for sharing and analyzing entities with which the data items will be shared; and
a security component for managing access to the collections of data items by the entities.

2. The system of claim 1, wherein the analysis component analyzes type and source of the data and the data items are shared based on the type and the source of the data.

3. The system of claim 1, further comprising a notification component for notifying a source of the data items of a security concern related to a recipient entity.

4. The system of claim 3, wherein the source modifies access to the data items in a communication to the recipient entity based on the security concern.

5. The system of claim 1, wherein the security component manages access to the data items according to a predetermined period of time.

6. The system of claim 1, wherein the data items are encrypted in a shared space and the encrypted items are accessed using a decryption key.

7. The system of claim 1, further comprising a rules component for creating and processing rules against the data items and entities which define sharing of the data items and access by the entities.

8. The system of claim 1, further comprising a preferences component for processing preferences of a source of the data items and preferences of the entities.

9. The system of claim 1, wherein the data items are shared from different sources, the data items associated with a query that is communicated to the entities.

10. A computer-implemented method of managing data, comprising:
receiving a dynamic collection of data items for sharing;
replicating the data items to a share location;
identifying one or more entities to access the data items;
qualifying the one or more entities for access to the data items; and
sharing the data items with the one or more entities.

11. The method of claim 10, further comprising determining ownership of each of the data items and qualifying access by the one or more entities based on the ownership.

12. The method of claim 10, further comprising determining sensitivity of a data item and qualifying access by the one or more entities based on the sensitivity.

13. The method of claim 10, further comprising restricting access to the data items based on a period of time.

14. The method of claim 10, further comprising automatically updating the data items in the share location based on version.

15. The method of claim 10, further comprising synchronizing the data items of the share location to another system.

16. The method of claim 10, further comprising notifying an owner of a data item and qualifying access to the data item by an entity based on the owner.

17. The method of claim 10, further comprising sending information about new items and updated items via a directory service.

18. The method of claim 10, further comprising specifying communications access methods for the one or more entities to access the data items.

19. The method of claim 10, further comprising continuously updating the data items in the share location based on a sliding window of time.

20. A computer-implemented system, comprising:
computer-implemented means for receiving a dynamic collection of data items for sharing;
computer-implemented means for replicating the data items to a share location;
computer-implemented means for identifying one or more entities to access the data items;
computer-implemented means for qualifying the one or more entities for access to the data items; and
computer-implemented means for sharing the data items with the one or more entities.
